(19) United States
(12) Patent Application Publication
(10) Pub. No.: US 2006/0033366 A1
(43) Pub. Date: Feb. 16, 2006

(54) Headrest display device

(76) Inventor: Vernon Michael Jeffrey, Ebenezer (NL)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/052,638

(22) Filed: Feb. 7, 2005

Related U.S. Application Data
(60) Provisional application No. 60/600,827, filed on Aug. 11, 2004.

(51) Int. Cl. A61G 15/00

(52) U.S. Cl. 297/220

(57) ABSTRACT

A seat headrest cover display device comprising: a first material portion, a median fabric portion attached to said first material portion, a second material portion attached to said median fabric portion, said second material portion having an opening to a viewing pocket, and having a viewing window disposed in said second material portion, said viewing window allowing for the viewing of the contents of the viewing pocket.

This application claims priority to earlier filed provisional application No. 60/600,827 filed on Aug. 11, 2004.

### FIELD OF THE INVENTION

The present invention relates generally to a removable device for advertising on a seat cover.

### BACKGROUND OF THE INVENTION

In the competitive marketplace, businesses are seeking more ways to advertise to consumers and get their message into the awareness of potential customers. In particular, the consumer on business travel or vacation travel is a desirable customer because, when away from home, travelers need to purchase more. Consumers are in a mood to spend while on their vacations, whereas business travelers often utilize an expense account. Traditional methods of advertising such as billboards are location specific, but are difficult to repaint or resurface to reflect current information, and of course they are suited for placement outdoors. Magazine and other print advertisements are updated frequently, and can be located near a consumer, but they lack the visibility of a posted advertisement.

There is a need for a customizable advertisement device that can be tailored to the traveler based on the particular destination of a traveler. It is also needed to provide an advertisement device that is easily updated or changed and can take advantage of the significant time a traveler spends in an airplane in anticipation of their intended destination.

United States Patent Application Publication US 2003/0164630 A1 discloses an automobile headrest cover that provides for a matching fabric and a logo on the forward facing side of the headrest cover.

U.S. Pat. No. 4,056,281 discloses a disposable back seat headrest cover that provides a hygienic, replaceable cover for an occupant. U.S. Pat. No. 4,099,772 discloses a replaceable headrest cover including a mechanism for securing the headrest cover to the headrest. U.S. Pat. No. 4,627,587 discloses an airplane seat cover with a detachable cushion that also serves as a flotation device.

None of the foregoing patents discloses a replaceable advertisement device for airplane seats.

### OBJECTS OF THE INVENTION

It is an object of the present invention to provide an airplane seat cover with an advertisement. It is a further object of the invention to provide a seat cover with a viewing window that is easily attached to an airline seat and is easily fitted with a new advertising piece.

### SUMMARY OF THE INVENTION

The invention is defined by the appended claims with specific embodiments shown in the attached drawings. For the purpose of summarizing the invention, the invention comprises a replaceable airline seat cover with a viewing window for receiving and displaying an advertisement.

Because travelers spend most of a trip in a seated position, it is desirable to provide an advertising system that places an advertisement in plain view of the traveler for the duration of the trip. It is also desirable to have a destination appropriate advertisement, especially for vacation destinations. Whereas national brands account for most advertising, it is the unique location-specific aspects of a destination that are both desired by travelers and most effectively advertised to travelers.

In one preferred embodiment of the invention, a seat head rest cover having a viewing pocket is presented. The viewing pocket is designed to receive and keep safe a promotional piece. The seat head rest cover is fitted with an elastic member or attachable strap. The inside of the cover can be fitted with a zippered opening for access to the viewing pocket. In other embodiments, the opening of the viewing pocket can be closed with other mechanical means such as snaps, hook and loop fastener, or clips.

The viewing pocket has a window made of translucent or transparent material on the outward side of the pocket so the contents of the pocket are viewable.

In another preferred embodiment, the contents of the viewing window are removable in a sleeve. The pocket is formed on the outside of the cover and the pocket has an opening that is accessible when the seat head rest cover is in place on a seat. This provides for a dispensable information piece so that a traveler can slide out and take the advertisement, coupon, map, or other information piece with them. In another preferred embodiment, the viewing pocket can be sized to receive an electronic image producing device that presents informative or entertainment images.

In some applications such as a commercial airline seat cover, the material of the cover is preferably composed of a fire resistant or fireproof material known in the art.

### BRIEF DESCRIPTION OF THE DRAWINGS

The foregoing summary, as well as the following detailed description of a preferred embodiment of the present invention will be better understood when read with reference to the appended drawings, wherein:

FIG. 1 presents an exploded view of a contoured embodiment of the invention.

FIG. 2 presents a perspective view of a contoured embodiment of the invention.

FIG. 3 presents a view of the inward surface of the second portion of an embodiment of the invention.

FIG. 4 presents a view of the outward surface of the second portion of an embodiment of the invention.

FIG. 5 presents a view of the outward surface of another embodiment of the invention.

FIG. 6 presents a view of yet another embodiment of the invention.

### DETAILED DESCRIPTION OF THE DRAWINGS

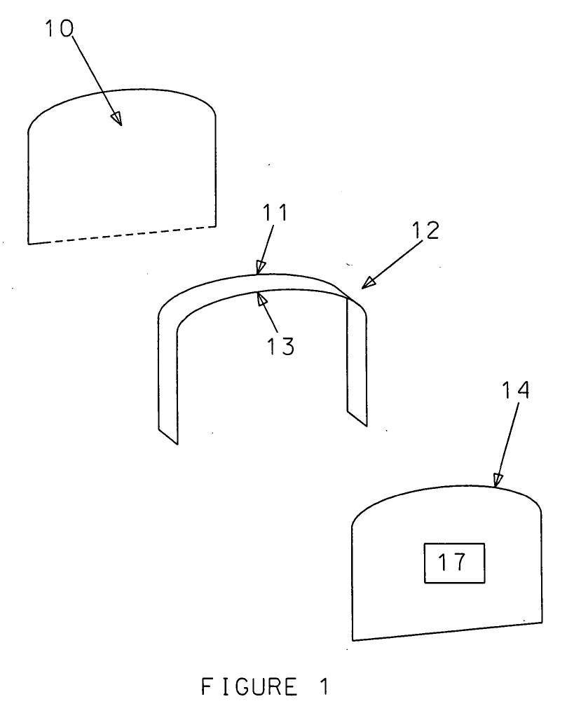

FIG. 1 presents an exploded view of a preferred embodiment of the invention. This embodiment provides display and protection for an information piece. First material portion 10 is contoured in shape to match the front surface of a seat head rest (not pictured). Second portion 14 is contoured in shape to match the rear surface of a seat head rest (not pictured). Median portion 12 has a first edge 11 designed to engage material portion 10 and a second edge 13 designed to engage material portion 14.

Material portion 14 contains a viewing window 17.

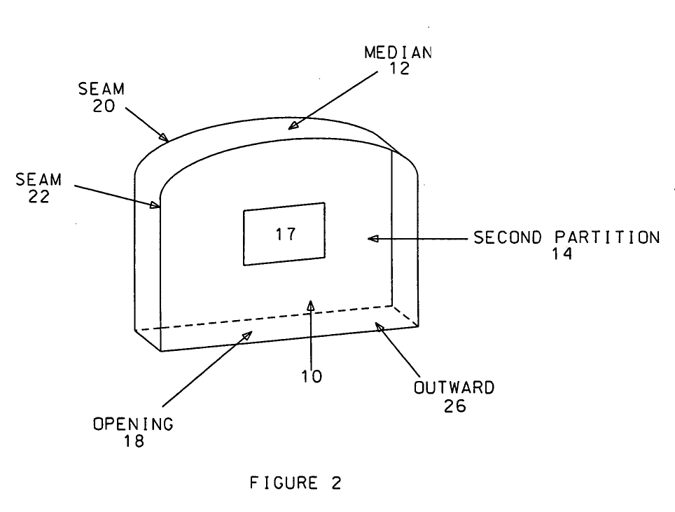

FIG. 2 presents a perspective view of a preferred embodiment of the invention. Median portion 12 is connected to first portion 10 at seam 20. Median portion 12 is connected to second portion 14 at seam 22. Outward surface 26 of second portion 14 surrounds substantially translucent viewing window 17. Connected portions 10, 12, and 14 define opening 18 suited for placement over a seat head rest.

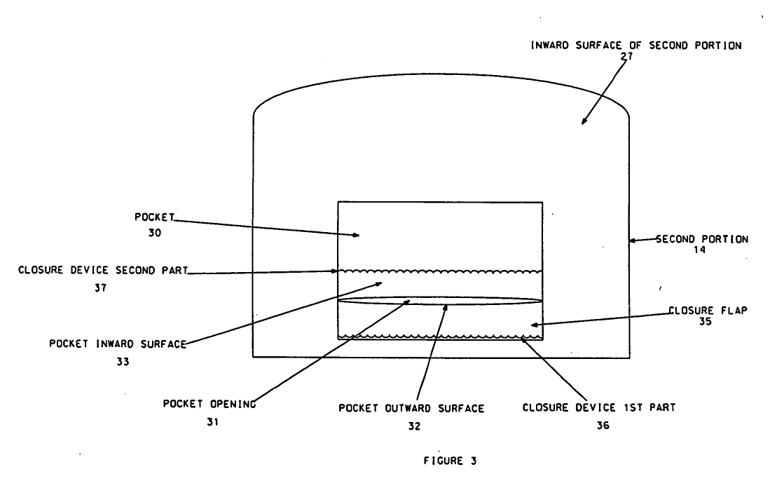

FIG. 3 presents the inward surface 27 of second portion 14. Formed on inward surface 27 is viewing pocket 30 composed of pocket inward surface 33 and pocket outward surface 32. Pocket opening 31 is defined by pocket outward surface 32 and pocket inward surface 33. Closure flap 35 is connected to inward surface 27 of second portion 14 and contains closure device first part 36. Disposed on pocket inward surface 33 is closure device second part 37. In this particular embodiment, 36 is a hook portion of a hook and loop device and 37 is the loop portion of a hook and loop device. In alternate embodiments, closure flap 35 can be secured with snaps, a zipper, hooks, or any other mechanical means known in the art.

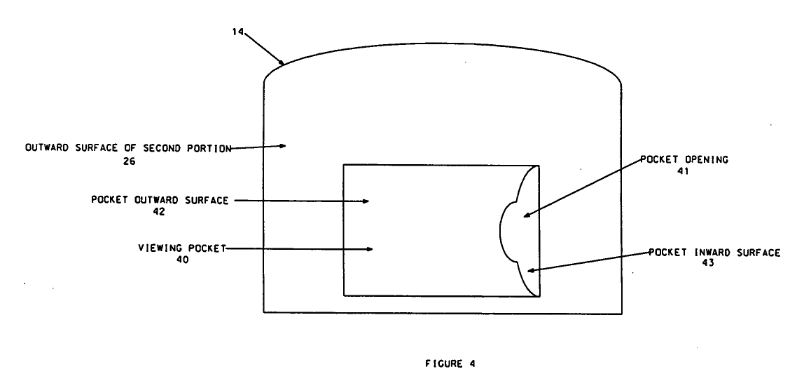

FIG. 4 presents another embodiment of the invention. Outward surface 26 of second material portion 14 is shown. This embodiment of the invention provides for a dispensable advertising piece. Pocket opening 41 is positioned on the outward surface 26 of second portion 14. Viewing pocket 40 has inward surface 43 and outward surface 42 that are joined at preferably three sides and open at pocket opening 41. In another preferred embodiment of the invention, the seat head rest cover of FIG. 4 is reversible allowing for dispensable piece when in the configuration shown in FIG. 4 and when reversed and placed on a seat head rest, the pocket opening 41 is not accessible and the advertising piece is not dispensable.

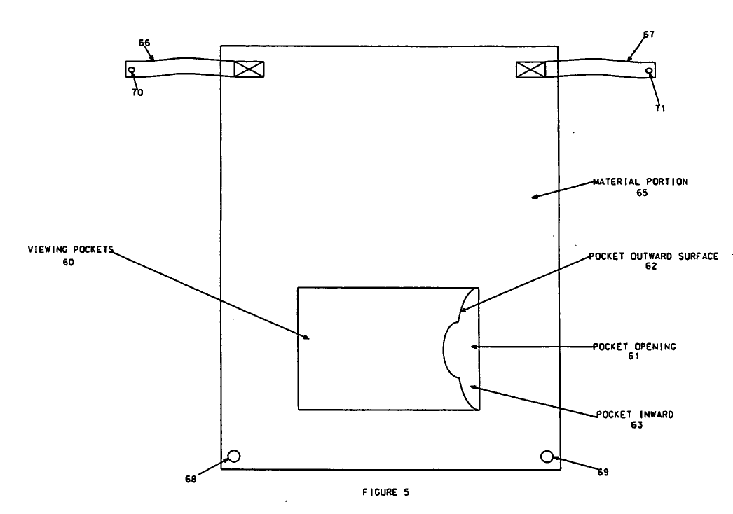

FIG. 5 presents yet another preferred embodiment of the invention. Material portion 65 surrounds viewing pocket 60. Viewing pocket 60 is formed by pocket outward surface 62 and pocket inward surface 63 that together define pocket opening 61. Material portion 65 is preferably the width of the seat head rest it is intended to cover. Material portion 65 is held in place on a seat head rest by straps 66 and 67 that contain snap closure female portions 70 and 71 suited to receive snap closure male portions 68 and 69 respectively. Other mechanical closure means known in the art can be utilized to secure material portion 65 to a seat head rest.

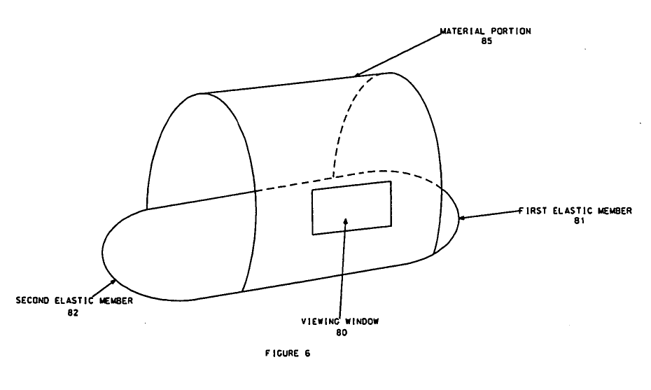

FIG. 6 presents still another embodiment of the invention. Material portion 85 surrounds viewing window 80 and is fitted with first elastic member 81 and second elastic member 82. This particular embodiment is easily fitted over a seat head rest and secured by the elastic nature of members 81 and 82.

1. A seat head rest cover display device comprising:
a first material portion, a median fabric portion attached to said first material portion,
a second material portion attached to said median fabric portion, said second material portion having a zipper opening to a viewing pocket, and having a viewing window disposed in said second material portion, said viewing window allowing for the viewing of the contents of the viewing pocket.

2. A seat head rest cover display device comprising:
A first material portion, a median fabric portion attached to said first material portion,
a second material portion attached to said median fabric portion, said second material portion surrounding a substantially translucent viewing pocket having a pocket opening and a closure flap to temporarily close said pocket opening,
said viewing pocket being suited to receive an advertising piece:

3. A seat head rest cover display device comprising:
a first material portion, a median fabric portion attached to said first material portion,
a second material portion attached to said median fabric portion, said second material portion surrounding a translucent viewing pocket having a pocket opening to receive an electronic image producing device.

4. A seat head rest cover display device as in claim 3 wherein said pocket opening is accessible on an outward surface of said second material portion.

5. A seat head rest cover display device as in claim 3 wherein said pocket opening accessible on an inward surface of said second material portion.

6. A seat head rest cover display device as in claim 3 wherein said seat heat rest cover display device is reversible so that when placed on a seat head rest in a first configuration said advertising piece can be removed from said viewing pocket and
when the device is placed on a seat head rest in a second configuration said advertising piece can not be removed from said viewing pocket.

7. The seat head rest cover display device of claim 3 for use on an airplane seat.

8. The seat head rest cover display device of claim 3 for use on a bus seat.

9. A seat head rest cover display device as in claim 2 wherein said closure flap further comprises a zipper.

10. A seat head rest cover display device as in claim 2 wherein said closure flap further comprises a hook and loop mechanism.

11. A seat head rest cover display device as in claim 2 wherein said closure flap further comprises at least one snap.

12. A seat head rest cover display device as in claim 3 further comprising a fire resistant material.

13. A seat head rest cover display device comprising:
a substantially translucent viewing pocket having a pocket opening to receive an advertising piece, a material portion surrounding said viewing pocket, said material portion having a width approximately equal to a width of a desired seat head rest,
and a connecting member attached to said material portion to secure said material portion to said desired seat head rest.

14. A seat head rest cover display device as in claim 13 wherein said connecting member is removably connected to said material portion.

15. A seat head rest cover display device as in claim 13 wherein said connecting member is elastic.

16. A seat head rest cover display device as in claim 13 wherein said pocket opening is accessible from a first side of said material portion and said pocket is not accessible from a second side of said material portion.

17. A seat head rest cover display device as in claim 15 wherein said seat head rest cover is reversible.

18. A seat head rest cover display device as in claim 13 wherein said pocket opening is accessible from a first side of said material portion so that when said material portion is placed on a seat head rest with said first side exposed, said advertising piece can be removed from said viewing pocket and when said material portion is placed on a seat head rest with said first side confined, said advertising piece can not be removed from said viewing pocket.

19. A seat head rest cover display device as in claim 13 wherein said material portion is fire resistant.

20. A seat head rest display device as in claim 1 further comprising an electronic image producing device disposed in said viewing pocket.
